(19) United States
(12) Patent Application Publication
(10) Pub. No.: US 2025/0006904 A1
(43) Pub. Date: Jan. 2, 2025

(54) ELECTRODE FILM ROLLED WEB, ELECTRODE, AND ELECTRODE LAMINATE

(71) Applicant: FUJIMORI KOGYO CO., LTD., Tokyo (JP)

(72) Inventors: Takuo YONEDA, Tokyo (JP); Ryuichi SATOU, Tokyo (JP); Mitsuru TOKURA, Tokyo (JP); Ayumi ANDOU, Tokyo (JP); Yasuki HIRATA, Tokyo (JP); Tsutomu HAYASHI, Tokyo (JP)

(21) Appl. No.: 18/752,654

(22) Filed: Jun. 24, 2024

(30) Foreign Application Priority Data
Jun. 28, 2023 (JP) 2023-106185

(51) Int. Cl. H01M 4/36; H01M 4/02; H01M 4/62; H01M 10/0525; H01M 10/0587

(52) U.S. Cl. CPC H01M 4/366; H01M 4/622; H01M 4/625; H01M 10/0587; H01M 2004/028; H01M 10/0525

(57) ABSTRACT

An electrode film rolled web includes an adhesive layer, and a positive active material layer laminated on the adhesive layer, where the adhesive layer includes a particulate conductive material and a binder, the binder contains a first polyisobutylene that has a viscosity average molecular weight of 1,000,000 or more and a second polyisobutylene that has a viscosity average molecular weight of 10,000 or more and 100,000 or less, the conductive material is a carbon material, and the adhesive layer contains the conductive material in an amount of 15% by mass or more and 25% by mass or less, the first polyisobutylene in an amount of 25% by mass or more and 50% by mass or less, and the second polyisobutylene in an amount of 30% by mass or more and 60% by mass or less, based on 100% by mass in total of the conductive material and the binder.

### CROSS-REFERENCE TO RELATED APPLICATIONS

This application claims the priority based on Japanese Patent Application No. 2023-106185 filed on Jun. 28, 2023, the entirety of which is incorporated herein by reference.

### BACKGROUND

### Technical Field

The present invention relates to an electrode film rolled web, an electrode, and an electrode laminate.

### Related Art

In recent years, the importance of secondary batteries for use as power sources has been increased. Secondary batteries have been actively researched and developed, from small batteries such as power sources for portable electronic apparatuses to medium and large batteries such as batteries for electric vehicles and household storage batteries.

Secondary batteries each have a pair of electrodes each including an active material and an electrolyte disposed between the electrodes. The pair of electrodes includes a positive electrode including a positive active material and a negative electrode including a negative active material. As these electrodes, configurations are known, which have a laminate of an active material layer including a positive active material or a negative active material, and a current collector with excellent conductivity.

The active material layer mentioned above is formed by dispersing a powdery active material and a binder in a solvent to prepare a mixture in the form of slurry, coating the current collector with the obtained mixture, and pressing the current collector with the mixture thereon. The laminate of the active material layer and the current collector is cut into a desired battery shape, and used as an electrode (see, for example, Japanese Unexamined Patent Application, First Publication No. 2019-169444).

### SUMMARY

As described above, multistage processing such as preparing the mixture, coating with the mixture, drying, and pressing is necessary in order to fabricate the electrode. For simplifying the manufacturing process for secondary batteries and reducing the manufacturing cost, there is room for contrivance in terms of material.

The same problem may be caused not only in the secondary battery but also in other electrochemical elements such as a capacitor.

The present invention has been made in view of such circumstances, and an object of the invention is to provide a novel electrode film rolled web for use as a material for an electrode. In addition, another object of the present invention is to provide an electrode and an electrode laminate for which such an electrode film rolled web is used as a material.

The inventors have considered that if a material that has characteristics for being usable as an electrode, with sufficient mechanical strength, can be achieved without using any current collector, processes such as designing a more efficient electrochemical device and coating a current collector with a mixture as described above can be omitted. In addition, the material shaped in a film is considered to allow an electrochemical device to be easily manufactured by cutting the film (electrode film rolled web) and bonding the film to a battery element.

For solving the problems mentioned above, an aspect of the present invention includes the following aspects.

[1] An electrode film rolled web including: an adhesive layer; and a positive active material layer laminated on the adhesive layer and including a positive active material, where the adhesive layer includes a particulate conductive material and a binder, the binder contains a first polyisobutylene that has a viscosity average molecular weight of 1,000,000 or more and a second polyisobutylene that has a viscosity average molecular weight of 10,000 or more and 100,000 or less, the conductive material is a carbon material, and the adhesive layer contains the conductive material in an amount of 15% by mass or more and 25% by mass or less, the first polyisobutylene in an amount of 25% by mass or more and 50% by mass or less, and the second polyisobutylene in an amount of 30% by mass or more and 60% by mass or less, based on 100% by mass in total of the conductive material and the binder.

[2] The electrode film rolled web according to [1], where the breaking strength determined by the following measurement method is 0.4 MPa or more, and the elongation percentage is 3% or more and 7% or less at the breaking strength.

### (Measurement Method)

The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

[3] The electrode film rolled web according to [1] or [2], where the adhesive layer has a breaking strength of 0.3 MPa or more determined by the following measurement method, and has an elongation percentage of 30% or more at the breaking strength.

### (Measurement Method)

The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

[4] The electrode film rolled web according to any one of [1] to [3], where the adhesive layer has an adhesive strength of 0.05 N/cm or more in a 90° peeling test performed by the following measurement method.

### (Measurement Method)

A surface of the adhesive layer side of a test piece of 15 mm in width and 50 mm in length, cut out from the electrode film rolled web, is bonded onto the center of an Al foil of 15 mm in width and 60 mm in length. After bonding a paper tape that is longer than the test piece to the opposite side of the test piece from the adhesive layer side, the strength is measured in peeling the test piece with the paper tape by 90° at a speed of 20 mm/min while gripping the paper tape protruding from the test piece. The arithmetic mean value of measured values obtained by performing the same measurement three times is defined as the adhesive strength.

### (Bonding Condition)

Roll bonding under an environment at a pressure of 8.6 kg/cm, a speed of 1 m/min, and 25° C.

[5] The electrode film rolled web according to any one of [1] to [4], where a release film may be laminated on the adhesive layer.

[6] An electrode that may include the electrode film rolled web according to any one of [1] to [5] as a material.

[7] An electrode laminate where the electrode according to [6] and any one selected from the group consisting of a current collecting foil, a separator, and a solid electrolyte membrane are laminated.

[8] An electrode laminate including: the electrode according to [6]; a first member laminated on a first surface of the electrode; and a second member laminated on a second surface of the electrode, where each of the first member and the second member is any one selected from the group consisting of a current collecting foil, a separator, and a solid electrolyte membrane.

According to the present invention, a novel electrode film rolled web for use as a material for an electrode can be provided. In addition, an electrode and an electrode laminate for which such an electrode film rolled web is used as a material can be provided.

### BRIEF DESCRIPTION OF DRAWINGS

FIG. 1 is a schematic view illustrating an electrode film rolled web 1 according to the present embodiment.

FIG. 2 is a schematic view illustrating an electrode film rolled web 2 according to the present embodiment.

FIG. 3 is a schematic view illustrating an electrode laminate 100.

FIG. 4 is a schematic view illustrating an electrode laminate 150 and a cell 500 including the electrode laminate 150.

### DETAILED DESCRIPTION

### <<Electrode Film Rolled Web and Electrode>>

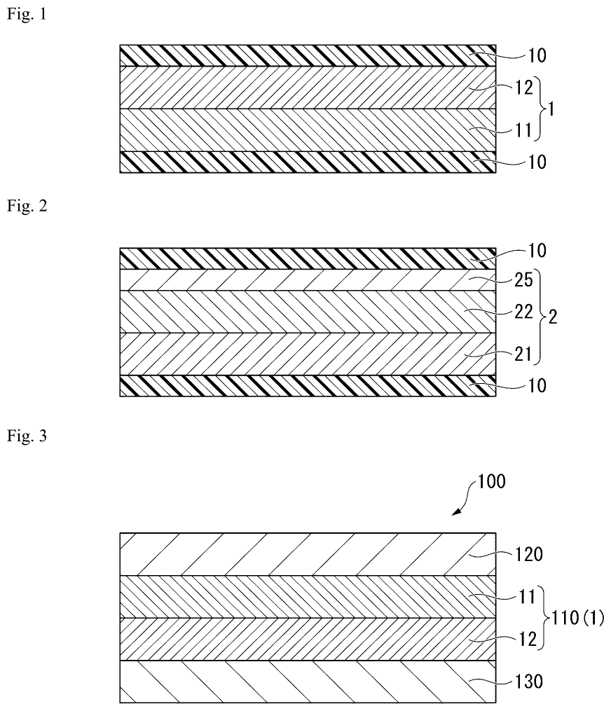

FIG. 1 is a schematic view (cross-sectional view) illustrating an electrode film rolled web 1 according to the present embodiment. An electrode according to the present embodiment includes the electrode film rolled web 1 as a material.

The term “electrode film rolled web” refers to a film-shaped molded body before being processed into an electrode. Typically, the electrode film rolled web is a long molded body formed in a strip shape, or a sheet-shaped molded body obtained by sheet-fed processing such a strip-shaped molded body.

The electrode film rolled web 1 shown in FIG. 1 is sandwiched between release films 10 from both surfaces. As the release films 10, known materials such as a release-treated PET film can be employed.

Further, the electrode film rolled web 1 in FIG. 1 has the release films 10 on both surfaces, but may have the release film 10 only on an adhesive layer 11.

The electrode film rolled web 1 is a laminate including the adhesive layer 11 and a positive active material layer 12. The electrode film rolled web 1 has no current collector.

The electrode film rolled web 1 has characteristic functions of (a) having adhesiveness, (b) being self-standing, and (c) being usable as an electrode.

### (a) Having Adhesiveness

The “adhesiveness” means a property that the electrode film rolled web 1 can be, due to the property of its surface, bonded to another member without separately using any adhesive or a pressure-sensitive adhesive. The electrode film rolled web 1 is cut into a desired shape, processed into an electrode, and then bonded to, for example, a plate material of a solid electrolyte to function as an electrode of a solid battery.

### (b) Self-Standing

The electrode film rolled web 1 can be cut into a desired shape to be processed into an electrode. The electrode film rolled web 1 may be used as an electrode as it is. The obtained electrode can maintain the cut shape without having any attachment such as a substrate. Having such a property may be referred to as “self-standing” or “self-standing type” in the present specification. In other words, the electrode film rolled web 1 has rigidity capable of existing without any support.

### (c) Usable as an Electrode

The electrode film rolled web 1 can be cut into a desired shape to be used as an electrode for an electrochemical device such as a secondary battery and a capacitor. In the present specification, whether the electrode film rolled web 1 is usable as an electrode is determined based on the value of a State of Charge (SOC)-Open Circuit Voltage (OCV).

The electrode obtained by cutting the electrode film rolled web 1 that has the functions of (a) and (c) can simplifies the operation of bonding the electrode to a member of an electrochemical device, and can be used as an electrode for an electrochemical device such as a secondary battery and a capacitor simply by bonding the electrode to a member of the electrochemical device. In addition, the electrode has the function of (b), and thus, is self-standing (a self-standing type electrode) and can be easily processed.

Hereinafter, the respective configurations of the electrode film rolled web 1 will be sequentially described.

### [Configuration of Electrode Film Rolled Web]

The electrode film rolled web 1 has a laminated structure of the adhesive layer 11 and the positive active material layer 12. As will be described in detail later, the electrode film rolled web 1 can be produced by, as an example, laminating a film corresponding to the adhesive layer 11 and a film corresponding to the positive active material layer 12.

### (Adhesive Layer)

The adhesive layer 11 includes a particulate conductive material and a binder. The adhesive layer 11 may further include a positive active material.

The adhesive layer 11 has a relatively high adhesive force, as compared with the positive active material layer 12. In addition, the adhesive layer 11 is relatively higher in strength than the positive active material layer 12 for securing the mechanical strength of the electrode film rolled web 1 as a laminate.

For achieving such physical properties, the binder constituting the adhesive layer 11 contains a first polyisobutylene that has a viscosity average molecular weight of 1,000,000 or more and a second polyisobutylene that has a viscosity average molecular weight of 10,000 or more and 100,000 or less. Specifically, the adhesive layer contains the conductive material in an amount of 15% by mass or more and 25% by mass or less, the first polyisobutylene in an amount of 25% by mass or more and 50% by mass or less, and the second polyisobutylene in an amount of 30% by mass or more and 60% by mass or less, based on 100% by mass in total of the conductive material and the binder.

In the adhesive layer 11, the conductive material is preferably 15% by mass or more and 30% by mass or less.

In the adhesive layer 11, the first polyisobutylene is preferably 28% by mass or more and 48% by mass or less, more preferably 30% by mass or more and 45% by mass or less.

In the adhesive layer 11, the second polyisobutylene is preferably 33% by mass or more and 58% by mass or less, more preferably 35% by mass or more and 55% by mass or less.

The viscosity average molecular weight of the first polyisobutylene is preferably 1,000,000 or more and 10,000,000 or less, more preferably 1,000,000 or more and 5,000,000 or less. As such a polyisobutylene, a commercially available polyisobutylene (for example, manufactured by BASF, model number: N150, viscosity average molecular weight: 2,600,000 (manufacturer's nominal value)) can be employed.

The viscosity average molecular weight of the second polyisobutylene is preferably 10,000 or more and 100,000 or less, more preferably 10,000 or more and 50,000 or less. As such a polyisobutylene, a commercially available polyisobutylene (for example, manufactured by ENEOS Corporation, model number: 6T, viscosity average molecular weight: 30,000 (manufacturer's nominal value)) can be employed.

A case is considered in which a third polyisobutylene that has a molecular weight equivalent to that of a mixture of the first polyisobutylene and the second polyisobutylene is used as the binder. Such a third polyisobutylene is lower in viscosity average molecular weight than the first polyisobutylene and higher in viscosity average molecular weight larger than the second polyisobutylene, but the study of the inventors has confirmed that when the third polyisobutylene (binder) and the conductive material are subjected to kneading, the conductive material is less likely to be dispersed, and the conductive material is aggregated.

In contrast, the binder is a mixture of the first polyisobutylene and the second polyisobutylene that different in viscosity average molecular weight, thereby allowing the dispersion of the conductive material to be promoted when the binder and the conductive material are subjected to kneading.

The conductive material in a particulate form is dispersed in the adhesive layer. The conductive material included in the adhesive layer is a carbon material.

Examples of the carbon material include known materials such as: carbon black such as acetylene black and Ketjen black; carbon fibers; activated carbon; and carbon nanotubes (CNT).

Commercially available acetylene black (for example, manufactured by Alfa Aesar, model number: 45527) or commercially available Ketjen black (for example, manufactured by LION SPECIALTY CHEMICALS CO., LTD., model number: EC600JD) can be employed as the carbon material.

As the conductive material, a material with a volume average particle size of 0.1 to 100 μm is used.

The adhesive layer 11 may contain therein other binders as long as the effects of the invention are not impaired. Examples of the other binders include a binder constituting the positive active material layer described later.

### (Positive Active Material Layer)

The positive active material layer 12 includes a positive active material and a binder.

### (Active Material)

Powdery materials known as positive active materials for secondary batteries and capacitors can be used as the active material.

In the case of employing a lithium ion secondary battery as the secondary battery, examples of the positive active material of the lithium ion secondary battery include at least one selected from materials such as composite oxides of lithium and a transition metal such as cobalt, manganese, and nickel, and polymers that have Li storage ability. The positive active material of the lithium ion secondary battery may be a compound that can be reversibly doped and dedoped with lithium ions.

Examples of the positive active material include a lithium cobalt oxide (LiCoO₂), a lithium manganese oxide (LiMnO₄), a lithium iron phosphate (LiFePO₄), a Ni—Mn—Co ternary (NMC-based) active material (LiNiₓMn_{y}Co_{z}O₂), and a Ni—Co—Al ternary (NCA-based) active material (LiNiₓCo_{y}Al₂O₂).

As the active material for the lithium ion secondary battery, a material with a volume average particle size of 0.1 to 100 μm is used.

When a lithium ion capacitor is employed as a capacitor, examples of the positive active material of the lithium ion capacitor include a carbon-based material such as activated carbon and a polymer that has a Li storage ability. The positive active material of the lithium ion capacitor may be a material that can be reversibly doped and dedoped with lithium ions.

As the active material for the lithium ion capacitor, a material with a volume average particle size of 0.1 to 100 μm is used.

### (Binder)

The positive active material layer 12 may be a known positive active material layer that is not self-standing only by the positive active material layer 12 itself. In this case, a polyvinylidene fluoride (PVdF) can be employed as the binder of the positive active material layer 12.

In addition, the positive active material layer 12 may be a layer that is capable of self-standing with the following binder.

The binder is a material for use in binding particles such as an active material, and for example, a resin is used for the binder. As the binder, a known thermoplastic resin can be employed, which is used for the above-mentioned purpose as an electrode material.

Examples of the functions of the binder include (i) imparting high strength to the electrode film rolled web, (ii) making an electrode produced from the electrode film rolled web likely to adhere to another member, and (iii) adjusting other physical properties, besides the above-described “binding particles such as an active material”. (ii) is not essential for having the functions (a) and (c) necessary for the “self-standing type electrode”, but is important for achieving the function (b). Binders that especially intensively have the functions of (i), (ii), and (iii) are referred to respectively as a “high-strength binder”, an “adhesive binder”, and “other binders”, and will be described.

It is to be noted that the adhesive layer 11 has the function (ii) in the electrode film rolled web 1 according to the present embodiment. It will be described herein that the binder constituting the positive active material layer 12 includes the adhesive binder, thereby making the binder likely to adhere to another member on the surface on the positive active material layer side.

### ((i) High-Strength Binder)

As the high-strength binder, an elastomer can be used. The binder that has properties as an elastomer can impart flexibility and strength to the electrode, and can keep the electrode from being broken due to a change in the volume of the active material during use of the electrode.

The high-strength binder desirably has a breaking strength of 5 MPa or more. In addition, it is necessary for the high-strength binder to be stable against an electrolytic solution inside the electrochemical element (battery or capacitor), and electrochemically stable.

For example, in the case of employing a lithium ion battery as the electrochemical element and using an electrode obtained by cutting the electrode film rolled web 1, it is necessary for the high-strength binder not to be eluted from the electrode into the electrolytic solution filling the battery. In addition, in the case of the electrode mentioned above for a positive electrode, it is necessary for the high-strength binder not to undergo oxidative decomposition at 3 to 5 V (vs. Li/Li⁺).

For the tensile strength of the high-strength binder, a value measured by a method for measuring the breaking strength as described later is employed.

As the binder, a copolymer containing a styrene and a conjugated diene can be used. Examples of such a copolymer include:
Styrene-butadiene copolymer (SBR);
Styrene-isoprene copolymer
Styrene-butadiene-methyl methacrylate copolymer (MBS)
Acrylonitrile-styrene-butadiene copolymer (ABS)
Acrylonitrile-styrene-butadiene-methyl methacrylate copolymer (MABS)
Carboxy-modified styrene butadiene rubber
Styrene-butadiene-styrene block copolymer (SBS)
Styrene-isoprene-styrene block copolymer (SIS)
Styrene-isoprene-butadiene-styrene block copolymer (SIBS).

The copolymers may be copolymerized with another copolymerizable vinyl-based monomer.

Examples of the vinyl-based monomer mentioned above include:
Acrylate-based monomer such as alkyl acrylate;
Methacrylate-based monomers such as alkyl methacrylates;
Acrylamide-based monomers such as alkoxyacrylamides;
Methacrylamide-based monomers such as alkoxymethacrylamides;
Carboxylic acid-based monomers such as acrylic acids;
Nitrile-based monomers such as acrylonitrile;
Vinyl ester-based monomers such as vinyl acetates;
Vinyl halide-based monomers such as vinyl chlorides; and
Polyfunctional monomers such as allyl acrylates.

One of these vinyl-based monomers may be copolymerized with the copolymer mentioned above, or two or more thereof may be copolymerized.

((ii) Adhesive Binder)

As the adhesive binder, a resin material that has a reactive functional group or an anchor effect can be used. Examples of the reactive functional group include a hydroxyl group (—OH) and a carboxy group (—COOH). When the electrode film rolled web contains such a binder, in bonding an electrode obtained from the electrode film rolled web to another member, the reactive functional group can be expected to react at the bonded surface to increase the adhesive strength.

In addition, the electrode film rolled web contains the adhesive binder, thereby making a self-standing type electrode produced from the electrode film rolled web likely to exhibit the function (ii) mentioned above.

Desirably, the adhesive binder is electrochemically stable and has adhesiveness even when the binder is exposed to other members, especially an electrolytic solution.

For example, in the case of employing a lithium ion battery as an electrochemical element and using an electrode obtained by cutting the electrode film rolled web 1, it is necessary for the adhesive binder not to be eluted from the electrode into an electrolytic solution filling the battery, and it is necessary for the reactive functional group to be unlikely to be deactivated even when the binder is exposed to the electrolytic solution.

In the case of the electrode mentioned above for a positive electrode, it is necessary for the adhesive binder not to undergo reductive decomposition at 3 to 5 V (vs. Li/Li⁺).

Examples of such a binder include at least one selected from carboxymethyl cellulose (CMC)-based binders, polyacrylic acid (PAA)-based binders, vinyl alcohol-based binders, and epoxy-based binders.

In addition, polyisobutylene (PIB) can also be used as the adhesive binder.

((iii) Other Binders)

Examples of binders that can be used in combination may include an acrylate-based binder, a polyvinylidene fluoride (PVdF)-based binder, and a polyimide-based binder. These binders are capable of compensating for the insufficient function as the electrode. For example, the (i) high-strength binder is considered electrochemically inactive, and when the active material is completely covered with the (i) high-strength binder, the electrochemical reaction of the active material is considered to fail to be developed, and the resistance of the electrode is considered to be increased. In contrast, the use of the (iii) other binders as described above in combination is considered to keep the resistance from being increased by covering the active material with the inactive binder.

The blending of the binders (i) to (iii) is adjusted depending on the intended physical properties, based on the following guidelines.

The (i) high-strength binder mainly plays a role of binding the active material in the electrode (electrode film rolled web). Thus, the amount of the (i) high-strength binder is adjusted in a positive correlation, depending on the amount of the active material used.

In addition, the (i) high-strength binder can impart flexibility and strength to the electrode as the amount of the (i) high-strength binder used for the active material is increased. Furthermore, the (i) high-strength binder may exhibit adhesiveness.

The (ii) adhesive binder imparts adhesiveness to the electrode film rolled web. The adhesiveness of the electrode is determined by the amount of the binder that exhibits adhesiveness, present per unit area (unit volume), and thus, the increased amount of the (ii) adhesive binder used improves the adhesiveness of the electrode.

The (iii) other binders are added, as necessary, for compensating for the insufficient function as the electrode.

Furthermore, the positive active material layer 12 may contain, besides the above-described active material and binder, an additive such as a conductive material, as necessary, for adjusting the physical properties. Examples of the conductive material include at least one selected from materials, for example, carbon black such as acetylene black, carbon fibers, activated carbon, metal powders, and conductive polymers. It is not necessary for the conductive material to have any activity like the active material, and may be any material that improves the conductivity inside the electrode.

In addition, the mixture constituting the electrode film rolled web may contain carbon nanotubes (CNT). The electrode film rolled web with CNTs added thereto can be expected to have an improvement in breaking strength and an improvement in conductivity.

### (Electrode Film Rolled Web)

The thickness of the electrode film rolled web 1 is preferably 1 μm or more and 1,000 μm or less.

The adhesive layer 11 is preferably 10% by volume or more and 20% by volume or less of the electrode film rolled web 1. In addition, the positive active material layer 12 is preferably 80% by volume or more and 90% by volume or less of the electrode film rolled web 1.

The adhesive layer 11 that has such a configuration described above is relatively more likely to be deformed and elongated than the positive active material layer 12. Thus, in the case of a stress applied to the electrode film rolled web 1, the whole shape of the electrode film rolled web 1 can be maintained (self-standing) without any breakage of the adhesive layer 11, even when the stress applied is enough to break the positive active material layer 12.

The electrode film rolled web 1 preferably satisfies the following requirements (1) and (3) for exhibiting the functions of (a) having adhesiveness and (c) being usable as an electrode. Furthermore, the electrode film rolled web preferably satisfies the following requirement (2) for exhibiting the function of (b) being self-standing.

### (Requirement (1))

The adhesive layer 11 of the electrode film rolled web 1 has an adhesive strength of 0.05 N/cm or more in a 90° peeling test. The electrode film rolled web 1 that satisfies the requirement (1) has the above-described feature of “(a) having adhesiveness”.

### (Method for Measuring Adhesive Strength)

The adhesive layer side of a test piece of 15 mm in width and 50 mm in length, cut out from the electrode film rolled web, is bonded onto the center of an Al foil of 15 mm in width and 60 mm in length. The bonding is performed under the following condition.

### (Bonding Condition)

Roll bonding under an environment at a pressure of 8.6 kg/cm, a speed of 1 m/min, and 25° C.

Specifically, the electrode film rolled web is cut into a width of 50 mm and a length of 150 mm, and bonded to an Al foil of 60 mm in width and 200 mm in length under the bonding condition. While maintaining the dimension of the obtained laminate in the lateral direction, the laminate is cut into a plurality of pieces in the longitudinal direction to obtain a laminate where the electrode film of 15 mm in width and 50 mm in length (the width of the original electrode film) is laminated on the Al foil of 15 mm in width and 60 mm in length (the width of the original Al foil). For the laminate, a paper tape that is longer than the test piece is bonded to the opposite side of the test piece from the adhesive layer side. The paper tape is used for keeping the adhesive layer from being stretched by traction during the test and appropriately measuring the adhesive strength. For the paper tape to be used, a paper tape with appropriate rigidity is preferably selected depending on the purpose.

The obtained laminate is attached from the Al foil side to a ring core of 11 cm in diameter, and while gripping the paper tape protruding from the test piece, the electrode film portion with the paper tape is pulled at a speed of 20 mm/min to perform a 90° peeling test. The adhesive strength can be determined as a value (N/cm) obtained by dividing the magnitude of the peeling force (N) in peeling the electrode film from the metal foil by the width (cm) of the electrode film.

The arithmetic mean value of three measured values obtained by performing the peeling test three times is employed for the adhesive strength.

As described above, the adhesive strength can be determined in the peeling test, and whether the requirement (1) is satisfied or not can be determined.

When the adhesive layer has such an adhesive strength, the electrode obtained from the electrode film rolled web is easily bonded to another member, and kept from being peeled due to its own weight. Thus, the subsequent assembling process is facilitated. In addition, the bonded electrode is unlikely to be peeled off, and the reliability of the electrochemical device obtained is improved.

The ratio of the binder to the whole mixture may be adjusted depending on physical properties that are necessary for the electrode film rolled web to be formed. When the adhesive force to other members such as a separator is prioritized for an electrode that is produced from the electrode film rolled web, the content ratio of the binder is preferably increased within the range mentioned above. When the electrical characteristics of the electrode are prioritized, the content ratio of the binder is preferably reduced within the range mentioned above.

### (Requirement (2))

As described above, the electrode film rolled web 1 preferably has the feature of “(2) being self-standing”. The electrode film rolled web 1 with such rigidity has a breaking strength of 0.4 MPa or more as determined by the following measurement method, and has an elongation percentage of 3% or more and 7% or less at the breaking strength.

### (Method for Measuring Breaking Strength and Elongation Percentage)

The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

In addition, the elongation percentage is determined by the following formula (1) from the inter-chuck distance of the test piece at the breaking strength.

$$Elongation Percentage ( \% ) = ( L 1 - L 0 ) / L 0 \times 100 \qquad ( 1 )$$

L0: initial value of inter-chuck distance (30 mm)
L1: inter-chuck distance at breaking strength

The magnitude of the tensile force (N) on the breakage of the test piece is defined as the maximum stress, and the stress of 75% of the maximum stress is determined. The value (N/mm²=MPa) obtained by dividing the stress (N) of 75% by the cross-sectional area (mm²) of the test piece in an imaginary plane orthogonal to the tensile direction is determined as the breaking strength.

The arithmetic mean value of three values obtained by performing the measurement three times is employed for the breaking strength.

The electrode film rolled web has such breaking strength, thereby allowing an electrode cut from the electrode film rolled web to be self-standing. Allowing the electrode to be self-standing makes it easy to handle the electrode in the subsequent assembly process.

The breaking strength is preferably 0.6 MPa or more, more preferably 0.7 MPa or more. In addition, the breaking strength can be considered preferably higher because the web is less likely to be broken, but the breaking strength may be 10 MPa or less, and may be 5 MPa or less.

In addition, the electrode film rolled web 1 has a feature of maintaining the shape and performance as a positive electrode against changes in volume during charging and discharging. The electrode film rolled web 1 has an elongation percentage of 3% or more at the breaking strength, thereby causing less deterioration due to changes in the volume of the positive active material during charging and discharging, and making it easy to maintain the performance of the positive electrode cut from the electrode film rolled web.

The arithmetic mean value of three values obtained by performing the measurement three times is employed for the elongation percentage.

The elongation percentage is preferably 4% or more, more preferably 5% or more.

Furthermore, the adhesive layer preferably has a breaking strength of 0.3 MPa or more determined by the method described in (Method for Measuring Breaking Strength and Elongation Percentage), and has an elongation percentage of 30% or more at the breaking strength.

The breaking strength of the adhesive layer is preferably 0.6 MPa or more, more preferably 0.7 MPa or more. In addition, the breaking strength can be considered preferably higher because the web is less likely to be broken, but the breaking strength may be 10 MPa or less, and may be 5 MPa or less.

The elongation percentage of the adhesive layer is preferably 20% or more, more preferably 30% or more. In addition, the elongation percentage of the adhesive layer may be 600% or less, and may be 500% or less.

The adhesive layer includes the positive active material, thereby allowing the adhesive layer to also function partially as the positive active material layer. The elongation percentage of the adhesive layer, however, tends to be decreased because the adhesive layer includes the positive active material. Thus, when the positive active material is included in the adhesive layer, the positive active material is preferably contained to such an extent that the elongation percentage is 150% or less, in order to give the technical meaning of containing the positive active material.

### (Requirement (3))

As described above, the electrode film rolled web 1 has the feature of “(c) being usable as an electrode”. As described above, whether the electrode film rolled web 1 is usable as an electrode is determined based on the SOC—OCV value.

### (Fabrication of Coin Cell for Measurement)

On a lower lid for the coin-type battery R2032, a test electrode prepared from the electrode film rolled web is disposed. On the test electrode, a separator (Celgard 2300 manufactured by Celgard, LLC) is disposed, and then, an electrolytic solution (1 mol/L solution of LiPF₆) is injected. As a solvent for the electrolytic solution, a mixed solvent obtained by mixing an ethylene carbonate, a diethyl carbonate, and an ethyl methyl carbonate at 1:1:1 (volume ratio) is used.

On the separator, a counter electrode (metal lithium) is disposed, and covered with a lid, and then, the whole is left to stand for 12 hours to immerse the whole in the electrolytic solution, thereby fabricating a lithium secondary battery (coin cell for measurement).

### (Method for Measuring SOC—OCV Value)

The amount of the active material included in the test electrode prepared from the electrode film rolled web is calculated, and the theoretical capacity (mAh/g) of the test electrode is determined from the theoretical capacity of the active material and the amount of the active material.

Then, with charging at 0.1 C for 30 minutes and pausing for 5 minutes as 1 time, the same operation is repeated 22 times in total for a coin cell for measurement.

The number of times of charging until the voltage reaches 0.05 V is defined as an SOC—OCV value.

In the present specification, when the SOC—OCV value measured by the method above is 18 times or more, the electrode film rolled web is determined to be adequately usable as an electrode.

When the electrode film rolled web shows such an SOC—OCV value, an electrode obtained from the electrode film rolled web adequately functions as a battery.

Furthermore, the electrode film rolled web 1 preferably has a volume resistivity of 80 mΩ or less. The electrical resistance of the electrode film rolled web 1 can be measured by the following method.

### (Method for Measuring Volume Resistivity)

First, the main surfaces of a pair of Cu blocks are superposed on each other, a load of 2 kg is then applied to the blocks, and zero-point calibration is performed. The Cu blocks used each have a main surface of 30×30 mm and a thickness of 20 mm.

Then, a test piece of the electrode film rolled web, sandwiched by an Al foil, is sandwiched between the main surfaces of the pair of Cu blocks, and a load of 2 kg is applied. The test piece and the Al foil are 30×30 mm in plane view, which is the same as the main surface of the Cu block.

Then, the resistance after 2 minutes is measured, and defined as the electrical resistance of the test piece. The electrical resistance is measured with the use of, for example, a battery high tester (model number: BT3562, manufactured by HIOKI E.E. CORPORATION).

In comparing the volume resistivity of different electrode film rolled webs with each other, the test pieces to be compared are controlled to have the same thickness. The thickness of the electrode film rolled web can be controlled by the method described in the production method described later.

In the case of applying a slurry including a positive active material onto an object (for example, a current collector) and compressing the coating film to form a positive active material layer, the interface between the positive active material layer and the object is considered sufficiently in close contact, and the interface resistance is considered sufficiently low. In contrast, in the case of bonding the positive active material layer to an object with a self-standing adhesive layer interposed therebetween as in the invention of the present application, the insufficient close contact of the interface between the adhesive layer and the object makes the interface resistance more likely to be increased, as compared with the above-described coating film. In addition, the interface between the positive active material layer and the adhesive layer is also considered to cause an interface resistance.

Thus, in the invention of the present application, it is determined that a sufficiently low interface resistance is achieved when the electrical resistance is measured by the method mentioned above to obtain a volume resistivity of 80 mΩ or less.

### [Method for Producing Electrode Film Rolled Web]

The electrode film rolled web can be produced by applying, onto a support, a slurry (coating material) obtained by dissolving or dispersing the above-described mixture in a solvent, removing the solvent to produce each of a film corresponding to the adhesive layer 11 and a film corresponding to the positive active material layer 12, and laminating the obtained films on each other.

For the solvent, a solvent that dissolves at least the binder is used. Examples of the solvent include a hydrocarbon-based solvent, an alcohol-based solvent, an ether-based solvent, a ketone-based solvent, an ester-based solvent, an amide-based solvent, a halogen-based solvent, a sulfur-based solvent, and an inorganic solvent.

Examples of the hydrocarbon-based solvent include heptane, cyclohexane, toluene, and xylene.

Examples of the alcohol-based solvent include methanol and ethanol.

Examples of the ether-based solvent include tetrahydrofuran and dioxane.

Examples of the ketone-based solvent include acetone and methyl ethyl ketone.

Examples of the ester-based solvent include ethyl acetate and ethyl lactate.

Examples of the amide-based solvent include dimethylformamide and N-methyl-2-pyrrolidone.

Examples of the halogen-based solvent include chloroform and dichloromethane.

Examples of the sulfur-based solvent include dimethyl sulfoxide and sulfolane.

Examples of the inorganic solvent include water.

Only one of the solvents mentioned above may be used, or a mixed solvent obtained by mixing two or more of the solvents may be used.

The method for preparing the coating material is not particularly limited, but the active material, the binder, an optionally added additive, and the like may be mixed with the solvent one by one, or two or more thereof may be mixed at the same time with the solvent, and dissolved or dispersed in the solvent.

The order of adding the solid contents (active material, binder, optionally added additive) to the solvent is not limited. The insoluble component may be added to a solution obtained by dissolving the soluble component in the solvent to disperse the insoluble component in the solution. In addition, the soluble component may be added to a dispersion obtained by dispersing the insoluble component in the solvent to dissolve the soluble component in the dispersion.

After the slurry or solution is prepared, a solvent may be further added to adjust the viscosity of the coating material.

The condition of the coating material may be adjusted by a treatment such as defoaming or filtration. Additives such as an antifoaming agent, a viscosity modifier, a thickener, a diluent, a surfactant, and a stabilizer may be added to the coating material.

The method for applying the coating material is not particularly limited, and examples thereof include blade coating, dip coating, spray coating, bar coating, and die coating.

The object (support) to which the coating material is applied is preferably a release-treated resin film. The support may be a long strip-shaped support, or may be a small sheet obtained by sheet-fed processing a long support.

By removing the solvent from the coating film formed by applying the coating material, a film corresponding to the adhesive layer 11 and a film corresponding to the positive active material layer 12 can be formed. The solvent can be removed by heating, depressurization, blowing, and a combination thereof.

The dried coating film may be subjected to pressing. For example, compressing the dried coating film with a pressing machine or the like can improve the contact states of particles such as the active material and conductive material included in the electrode.

The obtained films (the film corresponding to adhesive layer 11 and the film corresponding to positive active material layer 12) can be laminated to produce an electrode film rolled web. At the time of laminating the films, pressing is preferably performed.

In the case of using, as the support, a long strip-shaped support, the electrode film rolled web may be wound into a roll, stored, and transported, or may be further subjected to sheet-fed processing to provide a plurality of sheet-shaped electrode film rolled webs.

In this manner, the electrode film rolled web 1 is obtained.

FIG. 2 is a schematic view illustrating an electrode film rolled web 2 according to the present embodiment.

The electrode film rolled web 2 shown in FIG. 2 has an adhesive layer 21, a positive active material layer 22, and a functional layer 25. The electrode film rolled web 2 is also sandwiched between release films 10 from both surfaces. The adhesive layer 21 and the positive active material layer 22 may have the same configurations respectively as the adhesive layer 11 and the positive active material layer 12 described above.

Further, the electrode film rolled web 2 in FIG. 2 has the release films 10 on both surfaces, but may have the release film 10 only on an adhesive layer 21.

The electrode film rolled web 2 has no current collector.

The same mixtures as the mixture constituting the electrode film rolled web 1 described above can be employed for the mixtures constituting the adhesive layer 21 and the positive active material layer 22.

The functional layer 25 is provided in contact with the opposite surface of the positive active material layer 22 from the adhesive layer 21. The functional layer 25 is not particularly limited as long as the functional layer 25 is a layer attached for the purpose of improving the function of the electrode. Examples of the functional layer 25 include a heat dissipation layer, a flattening layer, a stress relaxation layer, and an adhesion layer.

The electrode film rolled web 2 can be produced by preparing the adhesive layer 21 and the positive material layer 22 corresponding to the electrode film rolled web 1 in the same manner as the electrode film rolled web 1 described above, and then preparing the functional layer 25 on the surface of the positive active material layer 22. The functional layer 25 can be appropriately produced by a known method with the use of a known material.

The electrode film rolled web that has such a configuration as described above can provide a novel electrode film rolled web for use as a material for an electrode.

In addition, the electrode that has such a configuration as described above has a sufficient adhesive force, and is easy to handle at the time of assembling a battery.

### [Electrode Laminate]

FIG. 3 is a schematic view (cross-sectional view) illustrating an electrode laminate 100. The electrode laminate 100 is a laminate where an electrode 110 and any one layer 120 selected from the group consisting of a current collecting foil, a separator, and a solid electrolyte membrane are laminated. The electrode 110 has the same configuration as the electrode produced from the electrode film rolled web 1 described above, and has a laminate of the adhesive layer 11 and the positive active material layer 12. The electrode 110 adheres to the layer 120 at the adhesive layer 11.

When the electrode laminate 100 is incorporated into a battery or a capacitor, the electrode 110 functions as a positive electrode. Hereinafter, the electrode 110 is referred to as a positive electrode 110.

When the layer 120 is a separator, the electrode laminate 100 including the positive electrode 110 and the separator is mainly used for an electrochemical device in which an electrolytic solution is used.

The separator is a material that insulates a positive electrode from a negative electrode and has ion permeability that is necessary for the function of the electrode. The separator is not particularly limited, and known resin films, porous membranes, and the like can be used.

Examples of the resin films include polypropylene, polyethylene, polyolefin, aramid, polyvinylidene fluoride, polyacrylonitrile, polyimide, polyamide, and polyethersulfone. For imparting ion permeability, the resin film may be made porous.

Examples of the porous membranes include a woven fabric, a nonwoven fabric, cellulose, and ceramic.

When the layer 120 is a solid electrolyte membrane, the electrode laminate 100 including the positive electrode 110 and the solid electrolyte membrane is used for an all-solid-state secondary battery, which is a type of electrochemical device.

The solid electrolyte membrane is a member obtained by processing a generally known solid electrolyte into a plate or a membrane. As a material for the solid electrolyte membrane, any of generally known inorganic solid electrolytes and polymeric solid electrolytes can be used.

As the inorganic solid electrolytes, any of sulfide-based inorganic solid electrolytes, oxide-based inorganic solid electrolytes, and other lithium-based inorganic solid electrolytes can be used.

Examples of the sulfide-based inorganic solid electrolytes include Li₂S—P₂S₅, Li₂S—SiS₂, Li₂S—GeS₂, Li₂S—Al₂S₃, Li₂S—SiS₂—Li₃PO₄, Li₂S—P₂S₅—GeS₂, Li₂S—Li₂O—P₂S₅—SiS₂, Li₂S—GeS₂—P₂S₅—SiS₂, and Li₂S—SnS₂—P₂S₅—SiS₂.

Examples of the oxide-based inorganic solid electrolytes include NASICON-type materials such as LiTi₂(PO₄)₃, LiZr₂(PO₄)₃, and LiGe₂(PO₄)₃, and perovskite-type materials such as (La_{0.5+x}Li_{0.5-3x})TiO₃.

Examples of the other lithium-based inorganic solid electrolyte materials include LiPON, LiNbO₃, LiTaO₃, Li₃PO₄, LiPO₄₋ₓNₓ (x is 0<x≤1), LiN, LiI, and LISICON.

Examples of the polymeric solid electrolytes include polymer materials that exhibits ion conductivity, such as a polyethylene oxide, a polypropylene oxide, and copolymers thereof.

When the layer 120 is a current collecting foil, the electrode laminate 100 including the positive electrode 110 and the current collecting foil is widely used for an electrochemical device. The electrode laminate 100 including the positive electrode 110 and the current collecting foil (layer 120) has a function of an electrode (positive electrode) as a whole. In such a case, the positive electrode 110 may adhere to the layer 120 at the positive active material layer 12, and may be bonded to a separator, a solid electrolyte membrane, or the like at the adhesive layer 11 of the positive electrode 110.

The positive electrode 110 may have another member 130 on the surface of the positive active material layer 12. Examples of the other member 130 include a protective film that protects the electrode surface. The protective film is not particularly limited as long as the film is a material capable of protecting the electrode from falling off of particles such as the active material at the surface of the electrode, any excessive reaction between the electrolyte and the electrode, and the like.

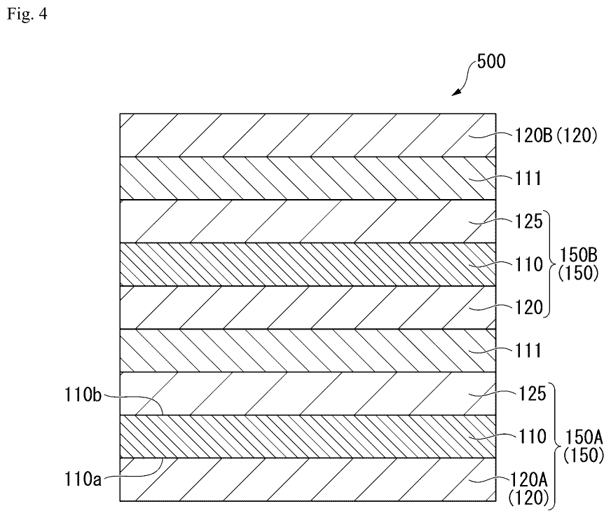

FIG. 4 is a schematic view (cross-sectional view) illustrating an electrode laminate 150 and a cell 500 including the electrode laminate 150. The electrode laminate 150 includes the positive electrode 110 described above, a first member 120 laminated on a first surface 110a of the positive electrode 110, and a second member 125 laminated on the second surface 110b of the positive electrode 110.

The first member 120 and the second member 125 are each any one selected from the group consisting of a current collecting foil, a separator, and a solid electrolyte membrane, and correspond to the layer 120 in FIG. 3. The first member 120 and the second member herein respectively serve as a current collecting foil and a solid electrolyte membrane.

The cell 500 has two electrode laminates 150, and a negative electrode 111 is sandwiched between the second member 125 of one electrode laminate 150A and the first member 120 of the other electrode laminate 150B. In addition, the negative electrode 111 and the first member 120 (first member 120B) are laminated in this order on the second member 125 of the electrode laminate 150B.

The positive electrode 110 and the negative electrode 111 each may have direct contact with the first member 120 and the second member 125, or may have another member sandwiched therebetween. As the other members, the same members as those described above can be employed.

The cell 500 functions as a bipolar battery including the first member 120A as a positive electrode side terminal and the first member 120B as a negative electrode side terminal.

In the cell 500 that has such a configuration, an electrode (positive electrode) formed from the electrode film rolled web described above is used for the positive electrode 110. The positive electrode 110 has the functions of (a) having adhesiveness and (b) being usable as an electrode, and thus, the positive electrode 110 is formed by cutting out from the electrode film rolled web, and stacked on the first member 120 or the second member 125, thereby allowing the interface to be easily bonded and allowing the positive electrode 110 and the member to be easily laminated.

### [Electrochemical Device]

The electrochemical device includes the electrode laminate mentioned above. Examples of the electrochemical device include a secondary battery and a capacitor.

Examples of the secondary battery include a battery cell, a module fabricated by connecting a plurality of cells, and a pack fabricated by connecting a plurality of modules. The product of the electrochemical device may include a sensor, a control circuit, and the like for keeping abnormalities such as overcharge and overdischarge from being caused. For electrically connecting the battery to the outside, a lead (terminal) may be attached to the electrode.

The electrode laminate including a separator is used for a secondary battery including an electrolytic solution. Examples of the electrolyte of a lithium ion secondary battery include a solution that has a lithium salt dissolved in a nonaqueous solvent. Examples of the lithium salt include LiPF₆, LiBF₄, LiAlCl₄, LiClO₄, CF₃SO₃Li, C₄F₉SO₃Li, CF₃COOLi, (CF₃CO)₂NLi, (CF₃SO₂)₂NLi, and (C₂F₅SO₂)₂NLi. Examples of the nonaqueous solvent include carbonates (carbonate esters) such as ethylene carbonate (EC), propylene carbonate (PC), dimethyl carbonate (DMC), diethyl carbonate (DEC), and ethyl methyl carbonate (EMC).

The electrochemical device can be fabricated by combining the electrode laminate mentioned above with other necessary members, for example, a separator, another electrode (counter electrode), and the like. The counter electrode may be different from the electrode according to the present embodiment.

The container for housing the electrode laminate can be formed from a laminate film, metal, or the like. The electrode laminate may be disposed in a flat form in the container, or may be housed in a from such as a curved, bent, or wound form.

### [Apparatus]

A module can be fabricated by connecting a plurality of cells. A pack can be fabricated by connecting a plurality of modules. The apparatus fabricated with the use of a battery such as a cell, a module, or a pack is not particularly limited, and examples thereof include electronic apparatuses such as a smartphone, a mobile phone, a computer, and a display, and transportation apparatuses such as an electric vehicle and a hybrid vehicle.

The preferred embodiments according to the present invention have been described above with reference to the accompanying drawings, but the present invention is not limited to such examples. The various shapes, combinations, and the like of the respective constituent members shown in the examples described above are merely examples, and various modifications can be made based on design requirements and the like without departing from the gist of the present invention.

### EXAMPLES

The present invention will be described below with reference to examples, but the present invention is not limited to these examples.

### Examples 1 to 4 and Comparative Examples 1 to 4

The respective materials used in examples and comparative examples are as follows.

### (Binder)

N150: polyisobutylene, manufactured by BASF, model number N150, viscosity average molecular weight 2,600,000
6T: polyisobutylene, manufactured by ENEOS Corporation, model number 6T, viscosity average molecular weight 30,000
PVdF: polyvinylidene fluoride, manufactured by Solvay, model number 5130

The N150 corresponds to the first polyisobutylene according to the present invention, and the 6T corresponds to the second polyisobutylene according to the present invention.

### (Active Material (Positive Active Material))

NCM: manufactured by Xiamen Tungsten Co., Ltd. (XTC), model number HEC400

### (Conductive Material)

AB: acetylene black, manufactured by Alfa Aesar, model number 45527
KB: Ketjen black, manufactured by LION SPECIALTY CHEMICALS CO., LTD., model number EC600JD

### (Production of Film Corresponding to Adhesive Layer)

The respective binders were dissolved in solvents to prepare solutions with the following concentrations.
N150: 6% by mass toluene solution
6T: 24% by mass toluene solution
PVdF: 6% by mass NMP solution

The obtained binder solutions were each mixed with the conductive material at the ratio shown in Table 1 in terms of binder to form a slurry. Toluene was further added to adjust the viscosity. Further, for some of the solutions, the active material was mixed at the ratio listed in Table 1 with respect to the total amount of the binder and the conductive material.

The slurry was defoamed and passed through a sieve with a mesh size of 100 μm to obtain respective coating materials S1 to S9 for adhesive layer formation.

The obtained coating materials S1 to S8 were each applied to a release-treated PET film. The coating materials were each applied to be constant in volume in accordance with the specific gravity. Specifically, the coating materials S5 to S8 including no active material were applied to be 10 g/m² (solid content). On the other hand, the coating materials S1 to S4 including the active material were applied to be 20 g/m² (solid content).

The obtained coating films were dried by heating the films at 90° C. for 5 minutes, and then pressed together with 10 μm spacers to adjust the thicknesses, thereby providing films A1 to A8 corresponding to the adhesive layer.

TABLE 1

| | Slurry | N150 | 6T | AB | KB | NCM |
|---|---|---|---|---|---|---|
| A1 | S1 | 63.9 | 15.9 | 15.9 | 4.3 | 480 |
| A2 | S2 | 39.9 | 39.9 | | | |
| A3 | S3 | 15.9 | 63.9 | | | |
| A4 | S4 | 30.0 | 47.5 | 15.0 | 7.5 | 400 |
| A5 | S5 | 30.0 | 50.0 | 20.0 | — | — |
| A6 | S6 | 45.0 | 40.0 | 15.0 | | |
| A7 | S7 | 30.0 | 60.0 | 10.0 | | |
| A8 | S8 | 23.1 | 69.2 | 7.7 | | |

(Production of Film corresponding to Positive Active Material Layer)

The conductive material (AB) in an amount equivalent to the binder in terms of binder was mixed with the PVdF solution described above to form a slurry. Toluene was further added to adjust the viscosity.

The slurry was defoamed and passed through a sieve with a mesh size of 100 μm to obtain a coating material for positive active material layer formation.

The obtained coating material was applied to a release-treated PET film so as to be 3 mAh/cm². Specifically, the mass per unit area (applied mass; unit: g/cm²) of the active material was calculated from the target capacity of the electrode and the specific capacity (unit: mAh/g) of the active material to be used, and the coating material was then applied. The coating film was dried by heating at 120° C. for 12 minutes. After the drying, the dried coating film was compressed with a roll press machine to be 3.2 g/cm³ in density, thereby providing a film corresponding to the positive active material layer. The amount (mass) of the positive active material was 2400 with respect to the total amount 100 of the binder and the conductive material.

### (Production of Electrode Film Rolled Web)

The film corresponding to the positive active material layer and the film corresponding to the adhesive layer, described above, were combined and laminated to fabricate electrode film rolled webs according to examples and comparative examples. In electrode film rolled web, the thickness of the positive active material layer and the thickness of the adhesive layer were respectively 80 to 90% and 10 to 20% (positive active material layer+adhesive layer=100%) with respect to the total thickness of the electrode film rolled web.

Physical property values were measured for each of the adhesive layers and electrode film rolled webs fabricated.

### [Measurement of Adhesive Strength]

The adhesive strength was measured by the method described in (Method for Measuring Adhesive Strength) described above.

### [Measurement of Breaking Strength]

The breaking strength and elongation percentage of the electrode film rolled web and the breaking strength and elongation percentage of the adhesive layer were measured by the method described above in (Method for Measuring Breaking Strength and Elongation Percentage).

### [Measurement of Resistivity]

The resistivity of the electrode film rolled web was measured by the method described above in (Method for Measuring Resistivity).

### [Measurement of SOC—OCV Value]

The SOC—OCV value was measured by the method described in (Method for Measuring SOC—OCV Value).

The evaluation results are shown in Tables 2 and 3. Table 2 shows the evaluation results of the films A1 to A8, and Table 3 shows the evaluation results of the electrode film rolled webs obtained by combining the films A1 to A8 and the positive active material layer.

TABLE 2

| | | Adhesive | Mechanical Properties | | Electrical | |
|---|---|---|---|---|---|---|
| | Adhesive | Force | Strength | Elongation | Resistance | SOC—OCV |
| | Layer | (N/cm) | (MPa) | (%) | (Ω) | 5%/time |
| Comparative | A1 | 0.02 | 0.65 | 17 | 67 | 16 |
| Example 1 | | | | | | |
| Example 1 | A2 | 0.06 | 0.39 | 38 | 65 | 16 |
| Comparative | A3 | 0.25 | 0.22 | 65 | 61 | 16 |
| Example 2 | | | | | | |
| Example 2 | A4 | 0.43 | 0.34 | 56 | 43 | 18 |
| Example 3 | A5 | 0.42 | 1.47 | 203 | 39 | — |
| Example 4 | A6 | 0.31 | 2.11 | 306 | 62 | — |
| Comparative | A7 | 0.69 | 1.43 | 258 | 124 | — |
| Example 3 | | | | | | |
| Comparative | A8 | 1.23 | 1.25 | 181 | 241 | — |
| Example 4 | | | | | | |

TABLE 3

| | | Mechanical Properties | | |
|---|---|---|---|---|
| | Adhesive | Strength | Elongation | SOC-OCV |
| | Layer | (MPa) | (%) | 5%/time |
| Comparative | A1 | 0.65 | 3.9 | 15 |
| Example 1 | | | | |
| Example 1 | A2 | 0.51 | 5.7 | 18 |
| Comparative | A3 | 0.34 | 7.3 | — |
| Example 2 | | | | |
| Example 2 | A4 | 0.42 | 6.2 | 19 |
| Example 3 | A6 | 0.49 | 5.5 | 21 |
| Example 4 | A7 | 0.57 | 3.8 | 20 |
| Comparative | A8 | — | — | 12 |
| Example 3 | | | | |
| Comparative | A9 | — | — | 6 |
| Example 4 | | | | |

The adhesive layers of the electrodes according to Examples 1 to 4 all exhibited adhesive strengths in excess of 0.05 N/cm at normal temperature, and thus, it has been suggested that the electrodes are easily bonded to other members. In addition, it has been successfully confirmed that the electrodes according to Examples 1 to 4 with the SOC—OCV value of 18 times or more are usable as electrodes.

Furthermore, it has been successfully confirmed that the electrodes according to Examples 1 to 4 are self-standing.

In contrast, the electrode according to Comparative Example 2 were low in breaking strength, and thus, have been found to have difficulty with self-standing. In addition, the electrode according to Comparative Example 1 was insufficient in adhesiveness at normal temperature.

Furthermore, the electrodes according to Comparative Examples 3 and 4 were insufficient in SOC—OCV value. This is considered due to the resistances of the adhesive layers.

That is, the electrodes according to Comparative Examples 1 to 4 fail to be considered as self-standing type electrodes with adhesiveness, and it has been successfully confirmed that the electrodes fail to solve the problem of the present invention.

From the foregoing results, the present invention has been found to be useful.

### DESCRIPTION OF THE REFERENCE NUMERALS

1,2 Electrode film rolled web
10 Release film
11, 21 Adhesive layer
12, 22 Positive active material layer
100, 150, 150A, 150B Electrode laminate
110 Electrode
110a First surface
110b Second surface
120, 120A, 120B First member
125 Second member

What is claimed is:

1. An electrode film rolled web comprising:
an adhesive layer; and
a positive active material layer laminated on the adhesive layer and including a positive active material,
wherein the adhesive layer includes a particulate conductive material and a binder,
the binder contains a first polyisobutylene that has a viscosity average molecular weight of 1,000,000 or more and a second polyisobutylene that has a viscosity average molecular weight of 10,000 or more and 100,000 or less,
the conductive material is a carbon material, and
the adhesive layer contains the conductive material in an amount of 15% by mass or more and 25% by mass or less, the first polyisobutylene in an amount of 25% by mass or more and 50% by mass or less, and the second polyisobutylene in an amount of 30% by mass or more and 60% by mass or less, based on 100% by mass in total of the conductive material and the binder.

2. The electrode film rolled web according to claim 1, wherein a breaking strength determined by the following measurement method is 0.4 MPa or more, and an elongation percentage is 3% or more and 7% or less at the breaking strength:
(Measurement Method)
The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

3. The electrode film rolled web according to claim 1, wherein the adhesive layer has a breaking strength of 0.3 MPa or more determined by the following measurement method, and has an elongation percentage of 30% or more at the breaking strength:
(Measurement Method)
The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

4. The electrode film rolled web according to claim 1, wherein the adhesive layer has an adhesive strength of 0.05 N/cm or more in a 90° peeling test performed by the following measurement method:
(Measurement Method)
A surface of the adhesive layer side of a test piece of 15 mm in width and 50 mm in length, cut out from the electrode film rolled web, is bonded onto the center of an Al foil of 15 mm in width and 60 mm in length; After bonding a paper tape that is longer than the test piece to the opposite side of the test piece from the adhesive layer side, the strength is measured in peeling the test piece with the paper tape by 90° at a speed of 20 mm/min while gripping the paper tape protruding from the test piece; An arithmetic mean value of measured values obtained by performing the same measurement three times is defined as the adhesive strength;
(Bonding Condition)
Roll bonding under an environment at a pressure of 8.6 kg/cm, a speed of 1 m/min, and 25° C.

5. The electrode film rolled web according to claim 1, wherein a release film is laminated on the adhesive layer.

6. An electrode comprising the electrode film rolled web according to claim 1 as a material.

7. An electrode laminate
wherein the electrode according to claim 6, and
any one selected from the group consisting of a current collecting foil, a separator, and a solid electrolyte membrane
are laminated.

8. An electrode laminate comprising:
the electrode according to claim 6;
a first member laminated on a first surface of the electrode; and
a second member laminated on a second surface of the electrode,
wherein each of the first member and the second member is any one selected from the group consisting of a current collecting foil, a separator, and a solid electrolyte membrane.
